(19) United States
(12) Patent Application Publication
(10) Pub. No.: US 2012/0270169 A1
(43) Pub. Date: Oct. 25, 2012

(54) TEMPERATURE-MEASURING SUBSTRATE AND HEAT TREATMENT APPARATUS

(75) Inventor: Kenichi YAMAGA, Oshu-Shi (JP)

(73) Assignee: Tokyo Electron Limited, Minato-Ku (JP)

(21) Appl. No.: 13/454,379

(22) Filed: Apr. 24, 2012

(30) Foreign Application Priority Data
Apr. 25, 2011 (JP) 2011-096675

(51) Int. Cl. F27D 19/00; G01K 7/32

(52) U.S. Cl. 432/49; 374/117; 374/E07.001

(57) ABSTRACT

A temperature-measuring substrate (50) for use in a heat treatment apparatus (2) for performing heat treatment of a substrate W to be processed, includes: a substrate body (62); an oscillator (64) including a piezoelectric element (68) and provided in the substrate body; and an antenna portion (66) connected to the oscillator and provided beside or around the periphery of the substrate body. The temperature-measuring substrate can reduce the attenuation of radio waves emitted by the oscillator.

### CROSS-REFERENCE TO RELATED APPLICATION

This application is based on and claims the benefit of priorities from Japanese Patent Application No. 2011-096675 filed on Apr. 25, 2011, the entire contents of which are incorporated herein by reference.

### TECHNICAL FIELD

The present disclosure relates to a heat treatment apparatus for performing heat treatment of a process-target substrate, such as a semiconductor wafer, and a temperature-measuring substrate for use in the heat treatment apparatus.

### BACKGROUND ART

In the manufacturing of a semiconductor integrated circuit such as IC, a semiconductor wafer, e.g. a silicon substrate, is generally subjected to a repetition of various treatments, including film forming processing, etching, oxidation/diffusion, annealing, etc. When a semiconductor wafer is subjected to heat treatment as typified by film forming processing, control of the temperature of the wafer is important. Thus, the temperature of a wafer is required to be controlled with high accuracy in order to maintain a high level of in-plane uniformity and uniformity among wafers of the film forming rate and the thickness of a film formed on the surface of the wafer.

In a vertical heat treatment apparatus which can process a plurality of wafers at a time, semiconductor wafers, held in multiple stages in a holder, are loaded (carried) into a vertical processing container, and film forming processing of the wafers is performed by heating the wafers and stabilizing their temperature by means of a heating unit provided around the processing container, and supplying a film forming gas into the processing container. Thermocouples are provided inside and/or outside the processing container so that based on temperatures detected by the thermocouples, the power supplied to the heating unit is controlled to keep the wafers at a predetermined temperature (see e.g. Japanese Patent Laid-Open Publications, JP10-025577A (document 1) and JP2000-077346A (document 2)).

The processing container of such a vertical heat treatment apparatus is long to such an extent as to be capable of housing about 50 to 150 wafers. Therefore, in order to preform temperature control with high accuracy and uniformly in the entire area of the processing container, the interior of the processing container is divided into a plurality of heating zones arranged in the vertical direction, and temperature control is performed individually for each heating zone. A relationship between the actual temperature of a dummy wafer provided with a thermocouple and the temperature of a thermocouple, provided inside or outside the processing container, is experimentally determined in advance. Upon heat treatment of product wafers, temperature control of the wafers is performed with reference to the predetermined relationship.

In the above-described temperature control method as disclosed in the documents 1 and 2, a wafer, whose temperature is to be measured, is not in direct contact with a thermocouple. Accordingly, the relationship between the actual temperature of a product wafer and a measured value of a thermocouple is not always constant. In particular, the relationship can change significantly upon a change e.g. in the flow rate of a gas, the processing pressure or the voltage applied, or when extraneous matter adheres to the inner wall surface of the processing container during a repetition of film forming processing. This makes it difficult to appropriately control the temperatures of wafers.

A technique for measuring the distribution of the temperatures of semiconductor wafers during heat treatment has been proposed. The technique involves placing temperature-measuring wafers, each provided in the surface with a temperature sensor comprised of a surface acoustic wave element or a piezoelectric element, in a wafer boat in a distributed manner along with product wafers, sending a high-frequency signal from an antenna to each temperature sensor and, based on temperature-dependent high-frequency signals sent back from the temperature sensors in response to the high-frequency signal, determining the distribution of the temperatures of wafers (see Japanese Patent Laid-Open Publications, JP2007-171047A (document 3), JP2009-265025A (document 4) and JP2009-302213A (document 5)).

High-frequency signals emitted by temperature sensors as disclosed in the documents 3 to 5 are very weak, which can cause difficulty in measuring the temperatures. Further, as the temperature of a silicon substrate increases and exceeds about 400° C., the surface resistance of the silicon substrate decreases and becomes conductive to a high-frequency signal emitted by a temperature sensor, which can produce a shielding effect on a high-frequency signal.

Furthermore, such restriction of the upper-limit temperature makes it difficult to meet the demand to measure in advance the distribution of the temperatures of semiconductor wafers during heat treatment or the temperature distribution characteristics in operation of a heat treatment apparatus.

### DISCLOSURE SUMMARY

The disclosure provides embodiments of a temperature-measuring substrate which can reduce the attenuation of radio waves emitted by an oscillator.

In one embodiment, there is provided a temperature-measuring substrate for use in a heat treatment apparatus for performing heat treatment of a substrate to be processed, which includes: a substrate body; an oscillator including a piezoelectric element and provided in the substrate body; and an antenna portion connected to the oscillator and provided beside or around the periphery of the substrate body.

In the above embodiment, since the antenna portion, to which an oscillator is connected, is disposed at the periphery of the substrate body, it is possible to prevent attenuation of radio waves emitted by the antenna portion even when the temperature-measuring substrate is at a high temperature.

In another embodiment, there is provided a heat treatment apparatus for performing heat treatment of a plurality of process-target substrates, including: an evacuable vertical processing container; a heating unit provided to heat the process-target substrates; a holding unit configured to hold the process-target substrates and the foregoing temperature-measuring substrate, and which is to be loaded into and unloaded from the processing container; a gas introduction arrangement configured to introduce a gas into the processing container; a transmitting antenna connected to a transmitter to transmit measuring radio waves to the temperature-measuring substrate; a receiving antenna connected to a receiver to receive radio waves emitted by the oscillator of the temperature-measuring substrate; a temperature analyzer configured to determine the temperature of the oscillator based on radio waves received by the receiving antenna; and a temperature controller configured to control the heating unit based on the temperature determined by the temperature analyzer.

In yet another embodiment, there is provided a heat treatment apparatus for performing heat treatment of a process-target substrate, including: an evacuable processing container; a heating unit provided to heat the process-target substrate; a substrate table configured to allow placement thereon of the process target substrate or the foregoing temperature-measuring substrate; a gas introduction arrangement configured to introduce a gas into the processing container; a transmitting antenna connected to a transmitter to transmit measuring radio waves to the temperature-measuring substrate; a receiving antenna connected to a receiver to receive radio waves emitted by the oscillator of the temperature-measuring substrate; a temperature analyzer configured to determine the temperature of the oscillator based on radio waves received by the receiving antenna; and a temperature controller configured to control the heating unit based on the temperature determined by the temperature analyzer.

The heat treatment apparatus in the above embodiment can control with good accuracy the temperature(s) of a substrate(s) to be processed based on the measured temperature of the temperature-measuring substrate.

In yet another embodiment, there is provided a heat treatment apparatus for performing heat treatment of a plurality of process-target substrates, including: an evacuable processing container; a heating unit provided to heat the process-target substrates; a rotatable substrate table configured to allow placement thereon the process-target substrates and the foregoing temperature-measuring substrate in different angular positions; a gas introduction arrangement configured to introduce a gas into the processing container; a transmitting antenna connected to a transmitter to transmit measuring radio waves to the temperature-measuring substrate; a receiving antenna connected to a receiver to receive radio waves emitted by the oscillator of the temperature-measuring substrate; a temperature analyzer configured to determine the temperature of the oscillator based on radio waves received by the receiving antenna; and a temperature controller configured to control the heating unit based on the temperature determined by the temperature analyzer.

The heat treatment apparatus in the above embodiment can control with good accuracy the temperatures of substrates to be processed based on the measured temperature of the temperature-measuring substrate. Furthermore, the temperatures of substrates to be processed can be measured even when the substrates are rotating or revolving. Thus, the temperatures of the substrates can be measured during heat treatment.

### BRIEF DESCRIPTION OF DRAWINGS

FIG. 1 is a vertical sectional view showing the construction a heat treatment apparatus, which uses a temperature-measuring substrate, in one embodiment;

FIG. 2 is a cross-sectional view showing a processing container;

FIG. 3 is a diagram showing the temperature control system of the heat treatment apparatus;

FIG. 4 shows a temperature-measuring substrate in a first embodiment, wherein (A) is a top plan view and (B) is a cross-sectional view;

FIG. 5 is a diagram illustrating the operating principle of an oscillator including a piezoelectric element;

FIG. 6 is a graph showing the relationship between the frequency deviation and the temperature of a piezoelectric element;

FIG. 7 is a diagram showing a variation of the temperature control system;

FIG. 8 shows plan views showing temperature-measuring substrates in a second embodiment (A) and a third embodiment (B);

FIG. 9 shows plan views showing temperature-measuring substrates in a fourth embodiment (A), a fifth embodiment (B), a sixth embodiment (C) and a seventh embodiment (D);

FIG. 10 is a plan view showing a temperature-measuring substrate in an eighth embodiment;

FIG. 11 shows a first variation of the heat treatment apparatus, wherein (A) is a cross-sectional view and (B) is a perspective view of a wafer table; and

FIG. 12 is a diagram showing a second variation of the heat treatment apparatus.

### DESCRIPTION OF EMBODIMENTS

Preferred embodiments will now be described with reference to the drawings. The following description illustrates the case of using a transmitting/receiving antenna which functions both as a transmitting antenna and as a receiving antenna.

The following description also illustrates the case of using a vertical heat treatment apparatus. The heat treatment apparatus 2 includes a processing container 8 of a double-tube structure, consisting of an inner quartz cylinder 4 and an outer quartz cylinder 6 with a closed top, concentrically disposed outside the inner cylinder 4. The outer circumference of the processing container 8 is covered by a heating unit 12 having a heater 10 so that substrates to be processed, housed in the processing container 8, are heated. The processing container 8 (including the interior) and the heating unit 12 constitute a heat treatment section 9.

The heating unit 12 has a cylindrical shape and surrounds almost the entire area of the side surface of the processing container 8. A heat insulator 14 is provided outside the processing container 8 such that it entirely covers the top and side portions of the processing container 8. The heating unit 12 is mounted on the inner circumferential surface of the heat insulator 14. A resistance heater such as a metal wire heater, a molybdenum heater or a carbon wire heater, or an induction heater may be used as the heater 10.

For performing zone temperature control, the processing container 8 is divided into a plurality of heating zones, e.g. five heating zones 16a, 16b, 16c, 16d, 16e as in this embodiment, arranged in the vertical direction. The heater 10 of the heating unit 12 is divided into five zone-heating heaters 10a, 10b, 10c, 10d, 10e, corresponding to the heating zones 16a to 16e, which are individually controllable. There is no particular limitation on the number of heating zones.

A feed line 19 extends from each of the zone-heating heaters 10a to 10e, and the feed lines 19 are connected to heating power sources 21a, 21b, 21c, 21d, 21e. The heaters, the feed lines and the power sources constitute the heating unit 12. The heating power sources 21a to 21e each include a switching element, such as a thyristor, so that the output power can be individually controlled by a phase control or a zero cross control. The zone-heating heaters 10a to 10e are provided with heater thermocouples 17a to 17e, respectively, as first temperature measuring arrangement 17 for detecting the temperatures of the heaters. The heater thermocouples 17a to 17e are housed in a quartz tube 23 which is corrosion-resistant and heat-resistant, and is disposed in an upright position inside the inner cylinder 4. In some cases, the heater thermocouples 17a to 17e may be located in the space between the inner cylinder 4 and the outer cylinder 6.

The lower end of the processing container 8 is supported by a cylindrical manifold 18, e.g. made of stainless steel, and the lower end of the inner cylinder 4 is supported on a support ring 20 mounted to the inner wall of the manifold 18. It is also possible to form a manifold 18, e.g. made of quartz, integrally with the processing container 8. A vertically-movable quartz wafer boat 22 as a wafer holding structure configured to hold a number of semiconductor wafers W as substrates to be processed, is disposed below the manifold 18 and can be inserted (loaded) into and withdrawn (unloaded) from the processing container 8. A semiconductor W having a diameter of 300 mm, for example, may be used though there is no particular limitation on a wafer size. The wafer boat 22 includes three or four support posts 22a which are provided such that they will lie in a semicircular area of a wafer W and which are fixed at the upper and lower ends. Each support post 22a, for example has groove portions arranged at a predetermined pitch in the vertical direction so that peripheral portions of a wafer W are held in corresponding groove portions of the support posts 22a.

The wafer boat 22 is mounted via a quartz heat-retaining cylinder 24 on a rotary table 26 which is supported on the upper end of a rotating shaft 30 which penetrates through a lid 28 for opening/closing the bottom opening of the manifold 18. The rotating shaft 30, in its portion penetrating through the manifold 18, is provided with e.g. a magnetic fluid seal 32 which rotatably supports the rotating shaft 30 while hermetically sealing the rotating shaft 30. A sealing member 34 such as an O-ring is interposed between the peripheral portion of the lid 28 and the lower end of the manifold 18 for sealing of the processing container 8.

The rotating shaft 30 is mounted to the front end of an arm 38 which is supported by a lifting mechanism 36, such as a boat elevator, so that the wafer boat 22, together with the lid 28, etc., can be moved vertically.

The manifold 18 is provided with a gas introduction arrangement 40. The gas introduction arrangement 40 has a gas nozzle 42 that penetrates through the manifold 18 so that a necessary gas can be supplied at a controlled flow rate. The gas nozzle 42 is, for example, made of quartz and extends in the longitudinal direction, i.e. the height direction, of the processing container 8 such that it covers the entire height of the wafer boat 22.

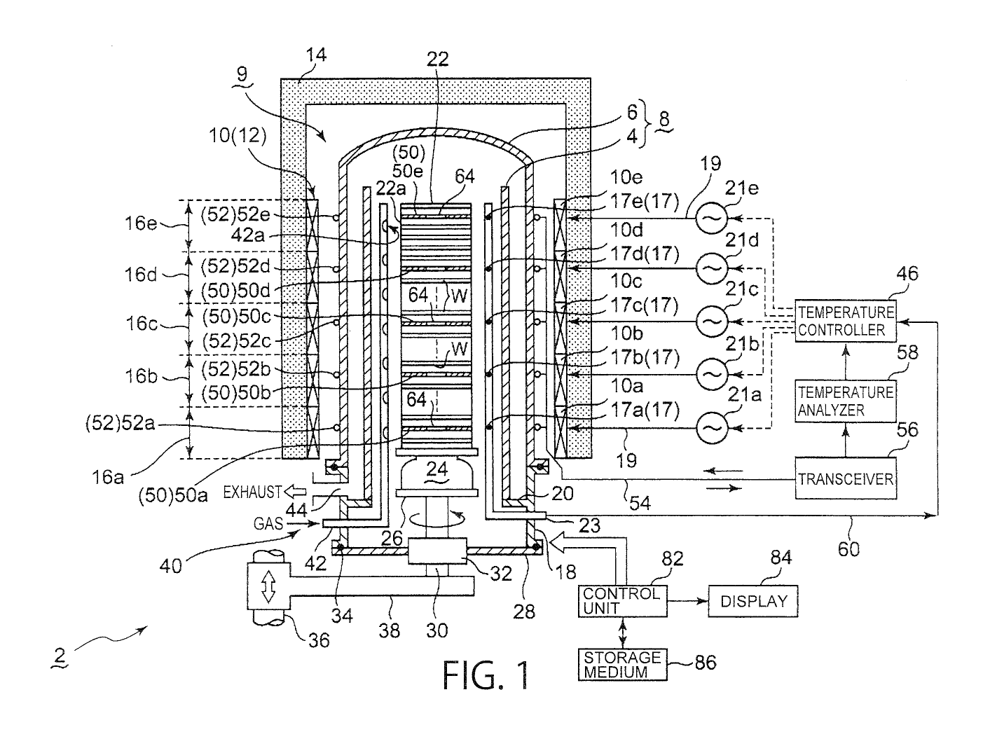

The gas nozzle 42 has a large number of gas holes 42a, e.g. arranged at an even pitch, from which the gas is to be jetted. Though only one gas nozzle 42 is depicted in FIG. 1, a plurality of gas nozzles may be provided practically depending on gases to be used. An exhaust port 44 is provided in the side wall of the manifold 18 to exhaust the atmosphere of the processing container 8 from between the inner cylinder 4 and the outer cylinder 6. The exhaust port 44 is connected to an evacuation system (not shown) in which a vacuum pump, a pressure regulation valve, etc., which are not shown, are interposed.

Detection values of the thermocouples 17a to 17e are inputted into a temperature controller 46 e.g. comprised of a computer. Upon processing of wafers, the detection values are supplementarily used to individually control the powers supplied to the zone-heating heaters 10a to 10e of the heating unit 12, as will be described later.

One or more temperature-measuring substrates 50 are housed in the wafer boat 22. The temperature-measuring substrates 50 are each designed to be substantially the same in thickness and size as a wafer W. In this embodiment five temperature-measuring substrates 50a, 50b, 50c, 50d, 50e, corresponding to the heating zones 16a to 16e, are held in the wafer boat 22.

The processing container 8 is provided with transmitting/receiving antennas 52 for transmitting measuring radio waves to the temperature-measuring substrates 50 and receiving radio waves emitted by the temperature-measuring substrates 50. In this embodiment the processing container 8 is provide with five transmitting/receiving antennas 52a, 52b, 52c, 52d, 52e, corresponding to the heating zones 16a to 16e. The transmitting/receiving antennas 52a to 52e are located on substantially the same level as the temperature-measuring substrates 50a to 50e held in the wafer boat 22, respectively, and are provided such that they are each wound around the outer cylinder 6 of the processing container 8. The transmitting/receiving antennas 52a to 52e may each be at least once, e.g. once as in this embodiment, wound around the processing container 8.

The transmitting/receiving antennas 52a to 52e are thus provided as close to the corresponding temperature-measuring substrates 50a to 50e as possible so that even weak signals can be efficiently received. Instead of thus disposing the transmitting/receiving antennas 52a to 52e outside the outer cylinder 6, it is possible to provide each of the transmitting/receiving antennas 52a to 52e within a narrow quartz tube, and dispose the tubes in the space between the inner cylinder 4 and the outer cylinder 6 or inside the inner cylinder 4 at positions where the tubes do not interfere with the wafer boat 22.

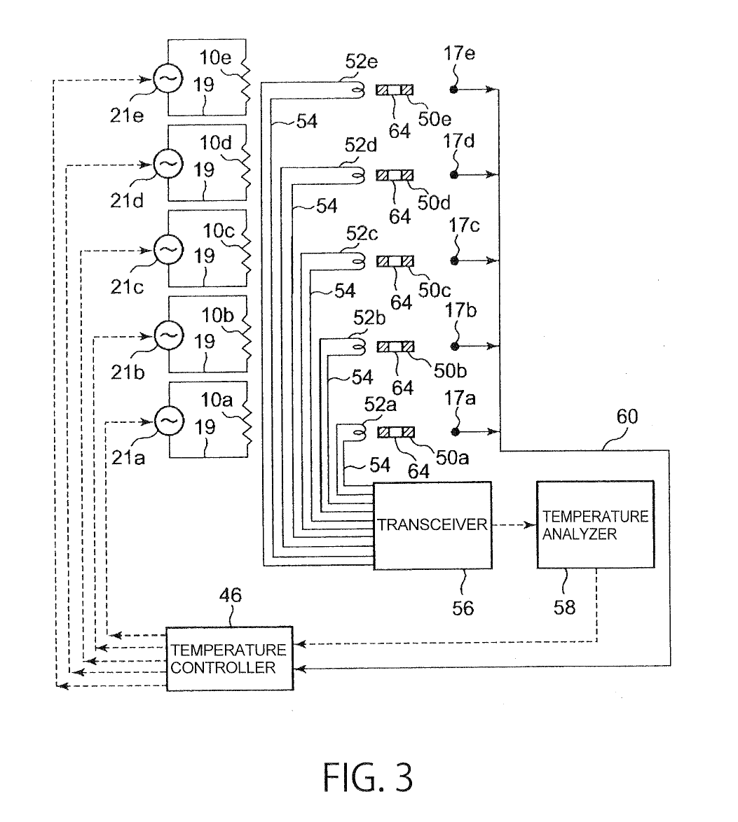

The transmitting/receiving antennas 52a to 52e are each connected via a conductive line 54 to a transceiver 56 (see FIG. 3). The transceiver 56 can transmit measuring radio waves from the transmitting/receiving antennas 52a to 52e and can receive radio waves emitted by the below-described oscillator of each temperature-measuring substrate 50. The transceiver 56 can sweep over a frequency zone around the natural frequency of an oscillator provided in a temperature-measuring substrate 50.

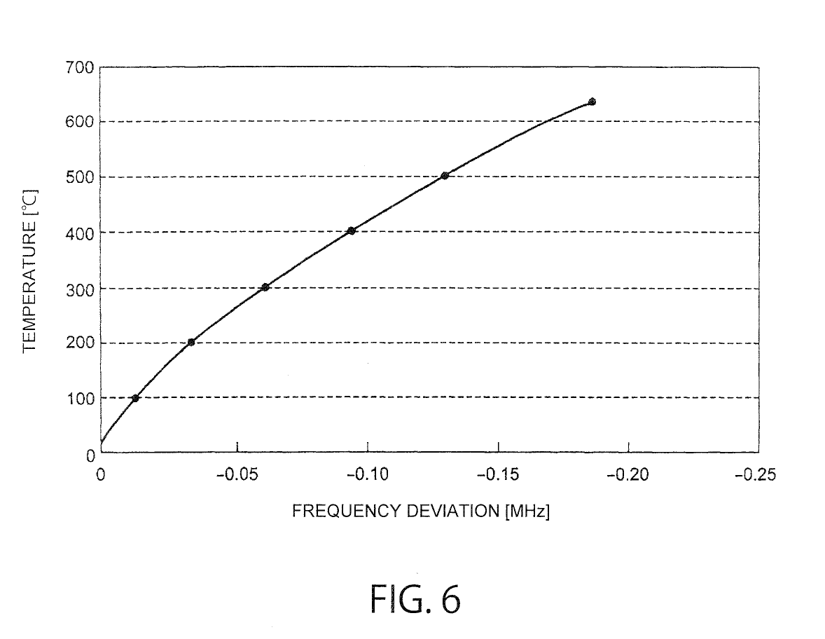

The transceiver 56 is connected to a temperature analyzer 58 which determines the temperatures of the temperature-measuring substrates 50a to 50e, i.e. the temperatures of the corresponding heating zones, based on radio waves received by the transmitting/receiving antennas 52a to 52e. A graph as shown in FIG. 6, showing the relationship between the frequency deviation (i.e., the shifting of resonance frequency with the change of temperature) and the temperature of a piezoelectric element 68, is stored as a temperature calculation function in the temperature analyzer 58. Based on the temperatures of the heating zones determined in the temperature analyzer 58, the temperature controller 46 outputs temperature control signals to the heating power sources 21a to 21e to individually and independently control the zone-heating heaters 10a to 10e. Instead of the transmitting/receiving antennas 52 (52a to 52e), it is possible to separately use transmitting antennas and receiving antennas. In that case, a transmitter and a receiver will be used instead of the transceiver 56.

The above-described heater thermocouples 17a to 17e are each connected via a thermocouple line 60 to the temperature controller 46. Temperature measurement values of the heater thermocouples 17a to 17e are supplementarily used for the temperature controller 46 to control the zone temperatures. The heater thermocouples 17a to 17e may be omitted.

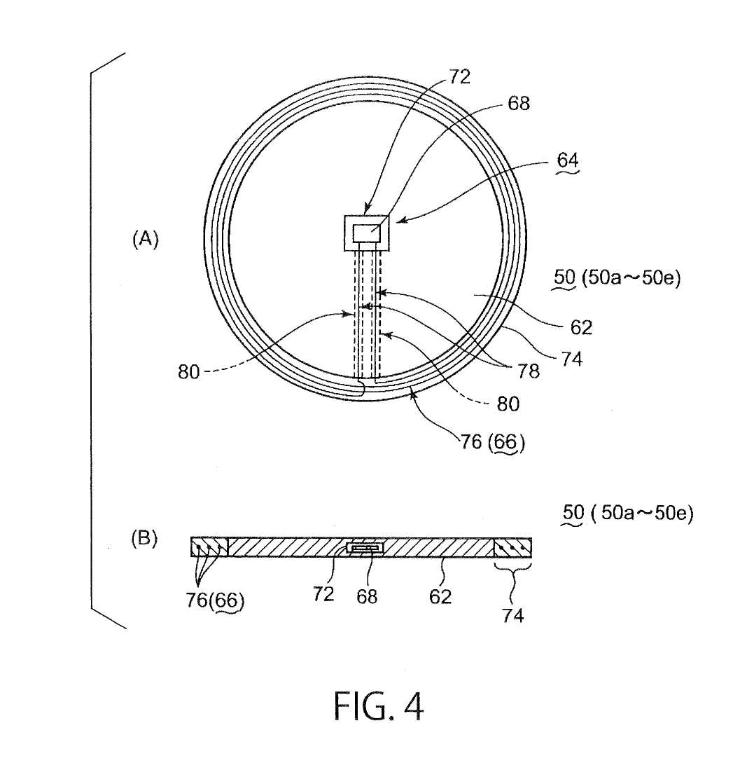

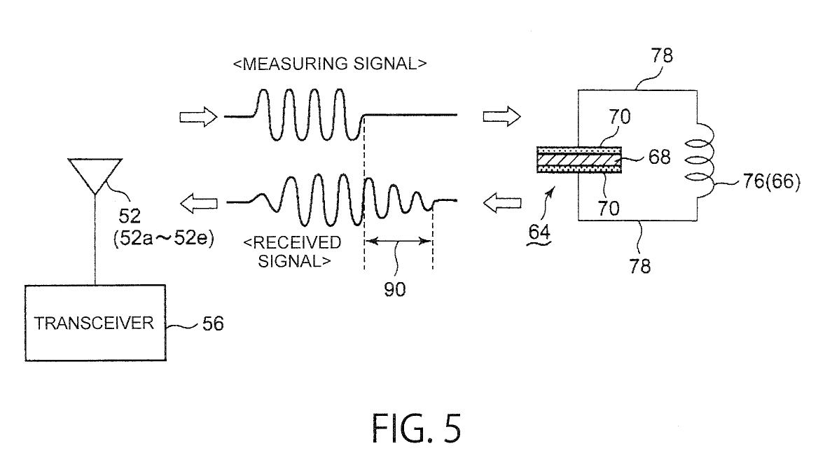

The temperature-measuring substrates 50 (50a to 50e) will now be described in detail. As shown in FIGS. 4A and 4B, the temperature-measuring substrate 50 according to a first embodiment is mainly comprised of a disk-shaped substrate body 62, an oscillator provided in the substrate body 62, and an antenna portion 66 provided around the substrate body 62. The oscillator 64 includes a piezoelectric element 68 having the shape of a thin plate, and a pair of electrodes 70 (see FIG. 5) bonded to both sides of the piezoelectric element 68. The entire piezoelectric element 68 is housed in an airtight case 72 e.g. made of an insulating material or a semiconducting material, and the case 72 is embedded in the substrate body 62.

Alternatively, the substrate body 62 may be composed of two thin substrates bonded together, with the oscillator 64 being confined between the substrates. When the two thin substrates are formed of the same material as a semiconductor wafer, such as silicon, there is no need to use the case 72. When thin quartz plates are used as the two substrates, the piezoelectric element 68 can be subjected to the same thermal conditions as a semiconductor wafer by forming the case 72 with the same material, such as silicon. It is possible to provide an exposure window in the substrate body 62 in its portion covering the case 72, so that the thermal response of the case 72 can be enhanced by its exposure to external heat.

An antenna installation portion 74, made of an insulating material, is provided around the substrate body 62, and the antenna portion 66 is disposed in the antenna installation portion 74. As shown in FIG. 4(A), the antenna installation portion 74 has the shape of a circular ring, and an antenna wire 76, constituting the antenna portion 66, is wound around the substrate body 62 (see FIG. 4(B)).

In the illustrated embodiment the antenna wire 76 has three turns concentrically wound around the substrate body 62, with both ends being connected via leading wires 78 to the pair of electrodes 70 provided in the piezoelectric element 68. The number of turns of the antenna wire 76 is not particularly limited, and is preferably an optimal number for the frequency of the oscillator 64. The leading wires 78 are each housed in a groove 80 whose surface is coated with an insulating material, such as aluminum, in order to insulate the leading wire 78 from the substrate body 62.

A material which is transparent to electromagnetic waves even at high temperatures, e.g. quartz or a ceramic material such as alumina, may be used as the insulating material of the antenna installation portion 74. A ceramic material such as alumina, or a semiconducting material such as silicon may be used as a material for the case 72 for housing the oscillator 64. The antenna wire 76 and the leading wire 78 may each be comprised of a wire of a conductive material, such as platinum or copper, e.g. having a diameter of about 0.2 mm. Lanthanum tantalic acid gallium aluminum (LTGA), for example, may be used as the piezoelectric element 68. Such a material has the property of changing its natural frequency (resonance frequency) with temperature. The piezoelectric element 68 has been processed so that it has a particular natural frequency, for example 10 MHz.

When signals emitted by the vertically-arranged temperature-measuring substrates 50a to 50e are so strong as to possibly cause signal interference, the natural frequencies of the oscillators 64 of the temperature-measuring substrates 50a to 50e are set different from one another. When there is no fear of signal interference because of weak signals, on the other hand, the natural frequencies of the oscillators 64 may be set equal to one another. In this embodiment the natural frequencies of the oscillators 64 of the temperature-measuring substrates 50a to 50e are set equal because of little fear of signal interference. The above-described temperature calculation function, showing the relationship between the frequency deviation and the temperature of a piezoelectric element, is stored in the temperature analyzer 58 as described above.

Though in this embodiment a graph as shown in FIG. 6 is used as a temperature calculation function, it is possible to use any temperature calculation function, for example, a computing function showing the characteristics of the graph. In this embodiment the temperature-measuring substrates 50 are each designed to have the same diameter and thickness as a silicon substrate to be processed so that the temperature-measuring substrates 50 can be easily housed and held in the wafer boat 22.

The width of the circular ring-shaped antenna installation portion is about 5 to 15 mm when the diameter of the temperature-measuring substrates 50 is 300 mm. The antenna wire 76, the leading wire 78, etc. may be formed by using a film forming technique such as plating, printing or photolithography. In that case, fusion bonding of quartz or a ceramic material as a cover is performed after the formation of a film.

Returning to FIG. 1, the overall operation of the thus-constructed heat treatment apparatus 2 is controlled by a control unit 82 e.g. comprised of a computer. Connected to the control unit 82 is a display 84 which displays necessary information, for example, temperatures determined by the temperature analyzer 58. The above-described temperature controller 46 is under the control of the control unit 82, and a computer program for performing the operation of the temperature controller 46 is stored in a storage medium 86, such as a flexible disc, a CD (compact disc), a hard disc, or a flash memory. The start and stop of the supply of a gas, the flow rate of the gas, the processing temperature and the processing pressure, etc. are controlled based on commands from the control unit 82. Outputs (temperatures) from the temperature analyzer 58 can be stored in the storage medium 86.

A heat treatment method, performed by means of the thus-constructed heat treatment apparatus, will now be described. A large number of semiconductor wafers W, to be subjected to heat treatment such as film forming processing, are first held in the wafer boat 22 in a standby or unloaded position in a loading area below the heat treatment apparatus 2. The wafer boat 22, holding wafers W at room temperature, is raised and loaded into the processing container 8, whose interior has been kept at a temperature equal to or slightly lower than the processing temperature, and the bottom opening of the manifold 18 is closed by the lid 28 whereby the processing container 8 is hermetically closed. Besides the product wafers W, the temperature-measuring substrates 50a to 50e are held in the wafer boat 22 at positions corresponding to the heating zones 16a to 16e.

While keeping the interior of the processing container 8 at a predetermined processing pressure, temperatures are detected by the heater thermocouples 17a to 17e and wafer temperatures are detected by radio waves from the oscillators 64 of the temperature-measuring substrates 50a to 50e. The powers supplied to the zone-heating heaters 10a to 10e are increased by the operation of the temperature control system shown in FIG. 3, whereby the temperatures of the wafers are raised and become stable at the predetermined processing temperature. Thereafter, a predetermined film forming processing gas is introduced from the gas nozzle 42 of the gas introduction arrangement 40 into the processing container 8.

After the processing gas is introduced from the gas holes 42a of the gas nozzle 42 into the inner cylinder 4 as described above, the gas comes into contact with the rotating wafers W and causes a film forming reaction at the wafer surfaces, and then the gas flows downward in the space between the inner cylinder 4 and the outer cylinder 6 and is discharged out of the processing container 8 through the exhaust port 44. Wafer temperature control during the processing is performed by determining wafer temperatures in the heating zones by radio waves emitted by the oscillators 64 of the temperature-measuring substrates 50a to 50e, and controlling, e.g. by PID control, the powers supplied to the zone-heating heaters 10a to 10e so that the wafer temperatures will become a predetermined target temperature.

The operating principle of the piezoelectric element 68 of the oscillator 64 will now be described with reference also to FIG. 5. The transceiver 56 is allowed to sweep over a frequency zone around a particular high frequency, corresponding to the natural frequency of the piezoelectric element 68 made of LTGA, and emit measuring radio waves as transmitting signals in a time-divisional manner. The transceiver 56 receives a radio wave as an output signal, having a resonance frequency corresponding to the temperature of the oscillator 64, outputted by the oscillator 64. The temperature of the relevant temperature-measuring substrates 50 can be detected by analyzing the frequency of the received signal. Such operating principle applies to the temperature-measuring substrates 50a to 50e.

While transmitting high-frequency measuring signals from the transceiver 56 in a time-divisional manner, a received signal is checked for a reverberation wave 90. With the antenna portion 66 provided around the temperature-measuring substrate 50, radio waves emitted by the temperature-measuring substrate 50 can be easily received by the transmitting/receiving antennas 52 of the transceiver 56. The presence of a reverberation wave 90 indicates resonance at the frequency. Accordingly, the temperature of the temperature-measuring substrate 50 can be determined from the graph shown in FIG. 6.

If a reverberation wave 90 is not detected in the received signal, then the above-described signal transmission and the check of a reverberation wave are performed at a frequency slightly changed from the previous one. Transmission of measuring signals at varying frequencies and scanning of received signals are repeated until detection of a reverberation wave. The frequency deviation in FIG. 6 is the difference between the natural frequency and the resonance frequency of the piezoelectric element 68. FIG. 6 shows the relationship in the case where the natural frequency of the piezoelectric element 68 is 10 MHz. As can be seen in FIG. 6, the frequency deviation gradually decreases with increase in the temperature.

The temperature of each of the temperature-measuring substrates 50a to 50e, and thus the temperature of each of the heating zones 16a to 16e can be measured directly in the above-described manner. Based on the measured temperatures, the temperature controller 46 controls the zone-heating heaters 10a to 10e individually and independently by means of the heating power sources 21a to 21e so that the wafer temperatures will become a target temperature. The wafer temperatures (temperature of the temperature-measuring substrates) can thus be measured and detected in a direct manner, and therefore can be controlled with high accuracy. The above-described sequence of control operations is repeated during a predetermined processing time.

With the antenna portion 66 provided in the peripheral portion of the temperature-measuring substrate 50 in this embodiment, radio waves emitted by the antenna portion 66 are unlikely to be attenuated, and can be easily received by the transmitting/receiving antenna 52. Furthermore, because the antenna portion 66 is provided in the antenna installation portion 74 made of insulating material, a radio-frequency shielding phenomenon will not occur even at high temperatures. This can further prevent attenuation of radio waves emitted by the antenna portion 66.

According to this embodiment, the temperatures of the temperature-measuring substrates 50a to 50e, and thus the temperatures of substrates (semiconductor wafers) W to be processed can be detected with good accuracy in a wireless and real-time manner without causing contamination of the substrates e.g. with a metal. This enables high-accuracy temperature control for substrates.

Even when raising or lowering the temperatures of substrates W to be processed, the temperatures can be measured in a direct manner. This enables accurate control of the rate of temperature increase or decrease, thus enabling appropriate control of the rise/lowering of the wafer temperature. Further, the temperatures of substrates W to be processed can be determined accurately even when a film adheres to the inner wall surface of the processing container 8.

Though in this embodiment the processing container 8 has a double-tube structure of the inner cylinder 4 and the outer cylinder 6, the present invention is not limited to such a structure. Thus, it is possible to use a processing container e.g. having a single-tube structure. Further, the present invention is not limited to the above-described constructions for the introduction of a gas and for the discharge of the in-container atmosphere; any construction may be used instead.

According to this embodiment, the antenna portion 66, to which the oscillator 64 is connected, is disposed around the substrate body 62 in each of the temperature-measuring substrates 50 (50a to 50e) for use in the heat treatment apparatus for performing heat treatment of substrates W to be processed. This can prevent attenuation of radio waves emitted by the antenna portion 66 especially when the temperature of the temperature-measuring substrate 50 (50a to 50e) is high.

<Variation of Temperature Control System>

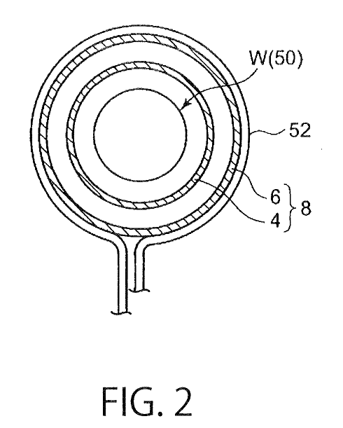

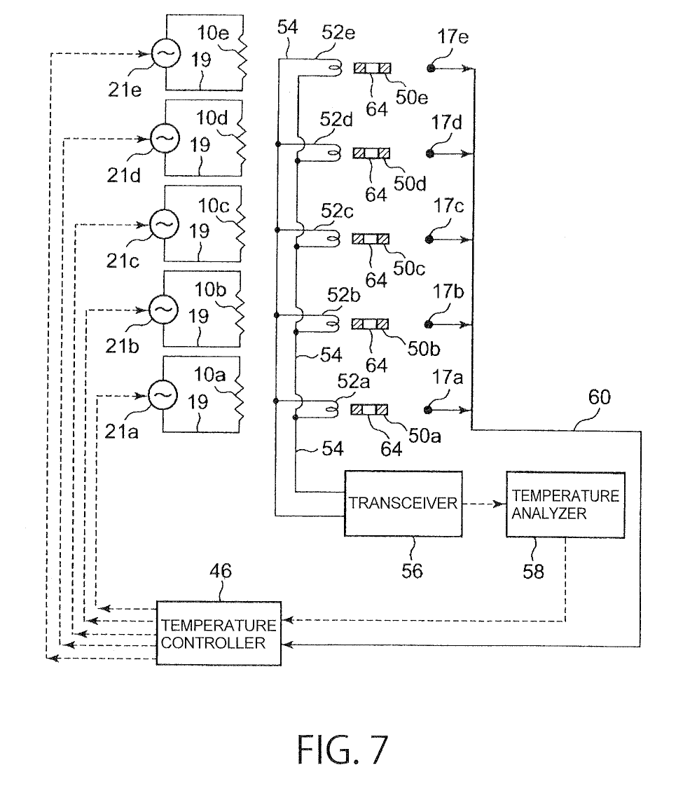

A variation of the temperature control system will now be described. Though in the temperature control system shown in FIG. 3 the transmitting/receiving antennas 52a to 52e are individually and independently connected to the transceiver 56, it is also possible to commonly connect the transmitting/receiving antennas 52a to 52e to the transceiver 56 as shown in FIG. 7. FIG. 7 shows such a variation of the temperature control system. In the following description, the same reference numerals are used for the same components or elements as those shown in FIGS. 1 through 6, and a description thereof will be omitted.

As shown in FIG. 7, in this embodiment the transmitting/receiving antennas 52a to 52e are commonly connected to the transceiver 56 by a feed line 54. In this case, the natural frequencies of the piezoelectric elements 68 of the oscillators 64 of the temperature-measuring substrates 50a to 50e are set at different values, for example, 10 MHz for the piezoelectric element 68 of the first temperature-measuring substrate 50a, 11 MHz for the piezoelectric element 68 of the second temperature-measuring substrate 50b, 12 MHz for the piezoelectric element 68 of the third temperature-measuring substrate 50c, 13 MHz for the piezoelectric element 68 of the fourth temperature-measuring substrate 50d, and 14 MHz for the piezoelectric element 68 of the fifth temperature-measuring substrate 50e. The natural frequency of a piezoelectric element can be changed by changing the cutout angle, the cutout thickness, etc. upon machining of a monocrystalline piezoelectric material.

Temperature calculation function (graphs) as shown in FIG. 6, showing the relationship between the frequency deviation and the temperature of each of the piezoelectric elements 68 having different natural frequencies, is stored in the temperature analyzer 58. In this embodiment the transceiver 56 outputs high-frequency measuring signals at varying frequencies, ranging from a frequency around 10 MHz to a frequency around 14 MHz, in a time-divisional manner. Every received signal is checked for the presence of a resonantly-generated reverberation wave 90 (see FIG. 5). The temperature of each of the temperature-measuring substrates 50a to 50e can be measured by detecting the presence of a reverberation wave 90. The temperature control system of this embodiment can achieve the same advantageous effects as described above with reference to the preceding embodiment shown in FIG. 3.

<Temperature-Measuring Substrates According to Second and Third Embodiments>

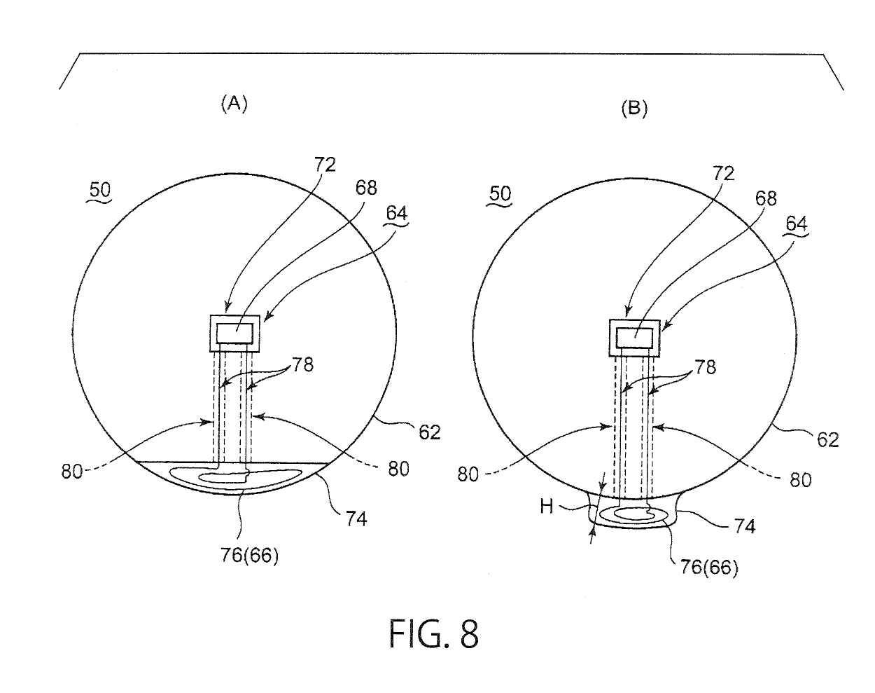

Temperature-measuring substrates according to second and third embodiments of the present invention will now be described. FIGS. 8A and 8B are plan views showing temperature-measuring substrates according to second and third embodiments of the present invention, respectively. In FIGS. 8A and 8B, the same reference numerals are used for the same components or elements as those shown in FIGS. 4A and 4B, and a description thereof will be omitted.

In the temperature-measuring substrate 50 shown in FIGS. 4A and 4B, the circular ring-shaped antenna installation portion 74 is provided around the substrate body 62. In the second embodiment shown in FIG. 8(A), on the other hand, a peripheral portion of a disk-shaped substrate body 62 is cut in a line, and an antenna installation portion 74 of insulating material, having the same shape as the cutout portion, is bonded to the cut site of the substrate body 62, e.g. by fusion bonding. An antenna portion 66, comprised of a coiled antenna wire 76, is formed in the antenna installation portion 74.

In this embodiment the diameter and the thickness of the substrate body 62 are set equal to those of semiconductor wafers W to be processed in order to avoid any trouble in carrying the substrate or a wafer into and out of the wafer boat 22. The temperature-measuring substrate of this embodiment can achieve the same advantageous effects as the temperature-measuring substrate of the preceding embodiment shown in FIGS. 4A and 4B.

In the third embodiment shown in FIG. 8(B), a projecting portion 75, projecting radially outward from a disk-shaped substrate body 62, is provided on a part of the periphery of the substrate body 62 as an antenna installation portion 74 of insulating material. The installation portion 74 is bonded to the substrate body 62 e.g. by fusion bonding. An antenna portion 66, comprised of a coiled antenna wire 76, is formed in the antenna installation portion 74. As with the above-described second embodiment, the diameter of the substrate body 62 is set equal to the diameter of semiconductor wafers W to be processed.

The length of the projecting antenna installation portion 74 in the circumferential direction of the substrate is set at such a length as not to interfere with the support posts 22a (see FIG. 1) of the wafer boat 22. The width H of the projecting antenna installation portion 74 in the radial direction of the substrate is set at such a width as not to cause any trouble in transport of the temperature-measuring substrate 50, e.g. not more than 20 mm.

The temperature-measuring substrate 50 of this embodiment can achieve the same advantageous effects as the temperature-measuring substrate of the preceding embodiment shown in FIGS. 4A and 4B. Furthermore, because the antenna installation portion 74 projects laterally according to the third embodiment, radio waves can be prevented from being adversely affected by silicon substrates, lying above and below the temperature-measuring substrate 50, during heat treatment.

<Temperature-Measuring Substrates According to Fourth to Eighth Embodiments>

Temperature-measuring substrates according to fourth to eighth embodiments of the present invention will now be described. Though in the above-described temperature-measuring substrates 50 according to the first to third embodiments, one oscillator 64 and one antenna portion 66 are provided for one temperature-measuring substrate 50, it is also possible to provide a plurality of oscillators and antenna portions connected to the oscillators for one temperature-measuring substrate 50.

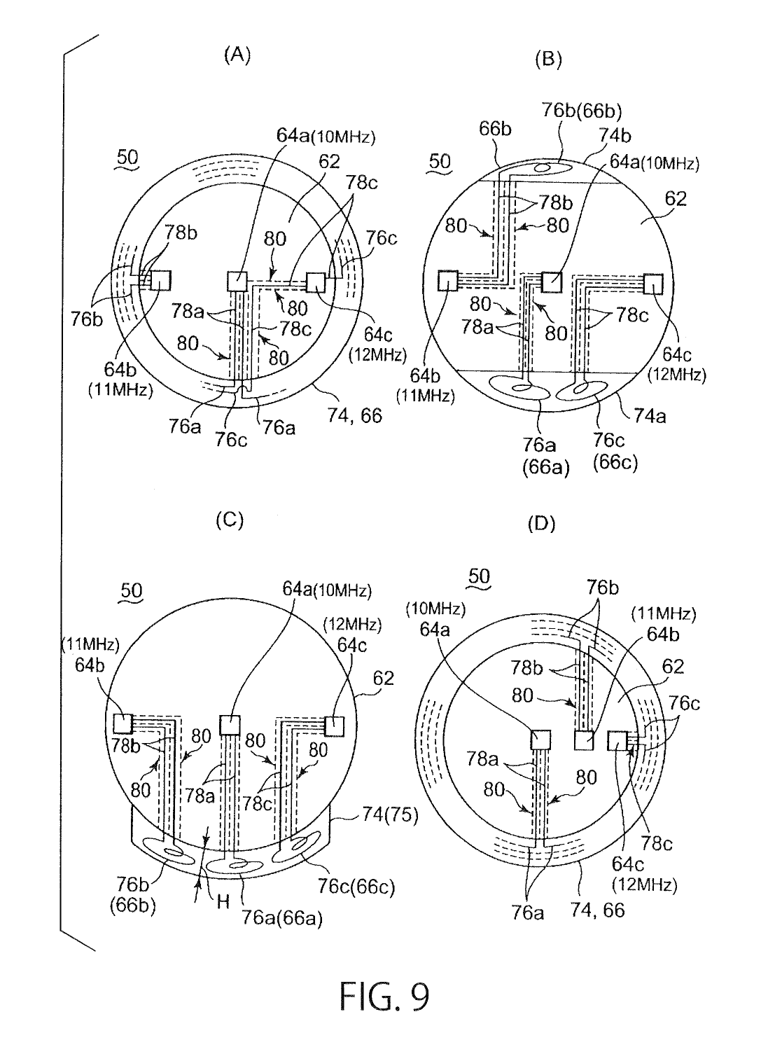

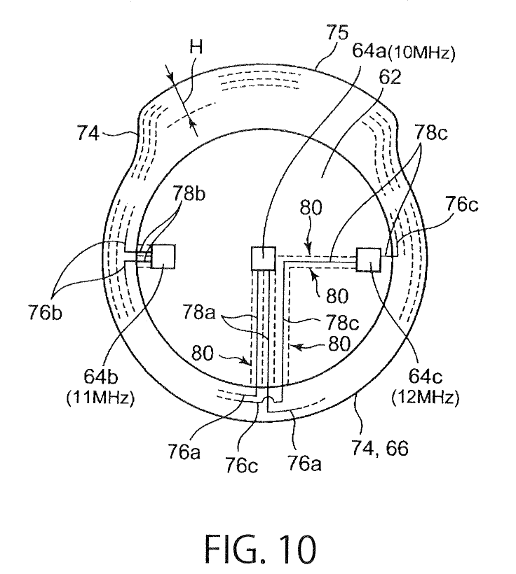

FIGS. 9A to 9D are plan views showing such temperature-measuring substrates according to fourth to seventh embodiments of the present invention, respectively. FIG. 10 is a plan view showing a temperature-measuring substrate according to an eighth embodiment of the present invention. In the Figures, the same reference numerals are used for the same components or elements as those shown in FIGS. 4 and 8, and a description thereof will be omitted. The following description illustrates a case in which three pairs of an oscillator and an antenna portion are provided for one temperature-measuring substrate; however, there is no particular limitation on the number of such pairs.

In the case of the temperature-measuring substrate 50 according to the fourth embodiment, shown in FIG. 9(A), the overall shape is the same as that of the first embodiment shown in FIGS. 4A and 4B, and a circular ring-shaped antenna installation portion 74 is formed around a disk-shaped substrate body 62. One oscillator 64a is provided in the center of the substrate body 62, and two oscillators 64b, 64c are provided in diametrically-opposite peripheral portions of the substrate body 62. Antenna wires 76a, 76b, 76c, constituting antenna portions 66a, 66b, 66c and disposed in the antenna installation portion 74, are connected via leading wires 78a, 78b, 78c to the oscillators 64a, 64b, 64c.

In this embodiment, the natural frequencies of the oscillators (piezoelectric elements) 64a to 64c are set at different values, for example, 10 MHz for the first oscillator 64a, 11 MHz for the second oscillator 64b, and 12 MHz for the third oscillator 64c. The antenna wire 76a of the first oscillator 64a has 3 turns wound in the circumferential direction of the substrate, the antenna wire 76b of the second oscillator 64b has 2 turns wound in the circumferential direction, and the antenna wire 76c of the third oscillator 64c has 1.75 turns wound in the circumferential direction; the antenna wires are optimized to increase their reception levels.

In this embodiment, temperature calculation function (graphs) as shown in FIG. 6, showing the relationship between the frequency deviation and the temperature of each of the oscillators 64a to 64c having different natural frequencies, is stored in the temperature analyzer 58.

The transceiver 56 outputs high-frequency measuring signals at varying frequencies, ranging from a frequency around 10 MHz to a frequency around 12 MHz, in a time-divisional manner. Every received signal is checked for the presence of a resonantly-generated reverberation wave 90 (see FIG. 5). The temperature of each of the oscillators 64a to 64c is measured by detecting the presence of a reverberation wave 90.

The temperature-measuring substrate 50 of this embodiment can achieve the same advantageous effects as described above with reference to FIG. 3. Furthermore, the in-plane distribution of the temperature of the temperature-measuring substrate 50 can be determined. Therefore, the temperatures of semiconductor wafers can be adjusted with good accuracy while rotating the wafer boat 22. The temperature distributions of semiconductor wafers during processing can be measured in real time.

In the case of the temperature-measuring substrate 50 according to the fifth embodiment, shown in FIG. 9(B), the overall shape is similar to that of the second embodiment shown in FIG. 8(A). A peripheral portion of a disk-shaped substrate body 62 is cut in a line, and an antenna installation portion 74a of insulating material, having the same shape as the cutout portion, is bonded to the cut site of the substrate body 62, e.g. by fusion bonding. In this embodiment an antenna installation portion 74b, having the same construction as the antenna installation portion 74a and located on the opposite side of the substrate center from the antenna installation portion 74a, is also bonded to the substrate body 62 e.g. by fusion bonding. The temperature-measuring substrate 50 has a disk-like shape as a whole.

As with the fourth embodiment, one oscillator 64a is provided in the center of the substrate body 62, and two oscillators 64b, 64c are provided in diametrically-opposite peripheral portions of the substrate body 62. Antenna wires 76a, 76b, 76c, constituting antenna portions 66a, 66b, 66c and disposed in the antenna installation portions 74a, 74b, are connected via leading wires 78a, 78b, 78c to the oscillators 64a, 64b, 64c. The antenna wires 76a, 76b are disposed in the antenna installation portion 74a, while the antenna wire 76c is installed in the antenna installation portions 74b, though this is not limitative of the present invention.

As with the fourth embodiment, the natural frequencies of the oscillators (piezoelectric elements) 64a to 64c are set at different values. As with the fourth embodiment, the transceiver 56 outputs high-frequency measuring signals at varying frequencies in a time-divisional manner. Every received signal is checked for the presence of a resonantly-generated reverberation wave 90 (see FIG. 5). The temperature of each of the oscillators 64a to 64c is measured by detecting the presence of a reverberation wave 90. The temperature-measuring substrate 50 of this embodiment can achieve the same advantageous effects as the temperature-measuring substrate of the fourth embodiment shown in FIG. 9(A).

In the case of the temperature-measuring substrate 50 according to the sixth embodiment, shown in FIG. 9(C), the overall shape is the same as that of the third embodiment shown in FIG. 8(B). A projecting portion 75, projecting radially outward from a disk-shaped substrate body 62, is provided as an antenna installation portion 74 of insulating material. As with the fourth embodiment, one oscillator 64a is provided in the center of the substrate body 62, and two oscillators 64b, 64c are provided in diametrically-opposite peripheral portions of the substrate body 62. Antenna wires 76a, 76b, 76c, constituting antenna portions 66a, 66b, 66c and disposed in the antenna installation portions 74a, 74b, are connected via leading wires 78a, 78b, 78c to the oscillators 64a, 64b, 64c. Also in this embodiment, the circumferential length and the radial width H of the projecting antenna installation portion 74 in the radial direction of the substrate are set at such a length and a width as not to cause any trouble in transport of the temperature-measuring substrate 50 and its transfer to the wafer boat 22.

As with the fourth embodiment, the natural frequencies of the oscillators (piezoelectric elements) 64a to 64c are set at different values. As with the fourth embodiment, the transceiver 56 outputs high-frequency measuring signals at varying frequencies in a time-divisional manner. Every received signal is checked for the presence of a resonantly-generated reverberation wave 90 (see FIG. 5). The temperature of each of the oscillators 64a to 64c is measured by detecting the presence of a reverberation wave 90. The temperature-measuring substrate 50 of this embodiment can achieve the same advantageous effects as the temperature-measuring substrates of the third embodiment shown in FIG. 8(B) and the fourth embodiment shown in FIG. 9(A).

In the case of the temperature-measuring substrate 50 according to the seventh embodiment, shown in FIG. 9(D), the overall shape is the same as that of the fourth embodiment shown in FIG. 9(A), and a circular ring-shaped antenna installation portion 74 is formed around a disk-shaped substrate body 62. The disk-shaped substrate body 62 is concentrically divided into three zones; and a first oscillator 64a is provided in the central zone, a second oscillator 64b is provided in the intermediate zone, and a third oscillator 64c is provided in the peripheral zone. Antenna wires 76a, 76b, 76c, constituting antenna portions 66a, 66b, 66c and disposed in the antenna installation portion 74, are connected via leading wires 78a, 78b, 78c to the oscillators 64a, 64b, 64c.

As with the fourth embodiment, the natural frequencies of the oscillators (piezoelectric elements) 64a to 64c are set at different values. As with the fourth embodiment, the transceiver 56 outputs high-frequency measuring signals at varying frequencies in a time-divisional manner. Every received signal is checked for the presence of a resonantly-generated reverberation wave 90 (see FIG. 5). The temperature of each of the oscillators 64a to 64c is measured by detecting the presence of a reverberation wave 90.

The temperature-measuring substrate 50 of this embodiment can achieve the same advantageous effects as the temperature-measuring substrate of the fourth embodiment shown in FIG. 9(A). Furthermore, the in-plane distribution of the temperature of the temperature-measuring substrate 50 can be determined. Because the oscillators 64a to 64c are distributed in the concentrically divided zones of the temperature-measuring substrate 50, the in-plane temperature distribution of the substrate can be determined with higher precision. Also in the fifth and sixth embodiments, the oscillators 64a to 64c can of course be disposed in the same manner as in the seventh embodiment.

The eighth embodiment shown in FIG. 10 is a combination of the fourth embodiment shown in FIG. 9(A) and the sixth embodiment shown in FIG. 9(C). Thus, in this embodiment, a circular ring-shaped antenna installation portion 74 is formed around a disk-shaped substrate body 62 and, in addition, a projecting portion 75, projecting radially outward from the ring-shaped antenna installation portion 74, is provided also as an antenna installation portion 74. The entire antenna installation portion 74, including the projecting portion 75, is formed of an insulating material. Antenna wires 76a, 76b, 76c are disposed in the entire antenna installation portion 74, including the projecting portion 75.

The temperature-measuring substrate 50 of this embodiment can achieve the same advantageous effects as the temperature-measuring substrate of the sixth embodiment shown in FIG. 9(C). Also in this embodiment, the oscillators 64a to 64c can of course be disposed in the same manner as in the seventh embodiment. The circular ring-shaped antenna installation portion 74 with the projecting portion 75 of this embodiment may be applied to the first embodiment which uses the single oscillator 64.

<First Variation of Heat Treatment Apparatus>

A first variation of the heat treatment apparatus will now be described. The heat treatment apparatus shown in FIG. 1 is adapted to process a large number of, for example not less than 10, semiconductor wafers W at a time. The present invention, however, can be applied to e.g. a heat treatment apparatus capable of processing several semiconductor wafers W at a time.

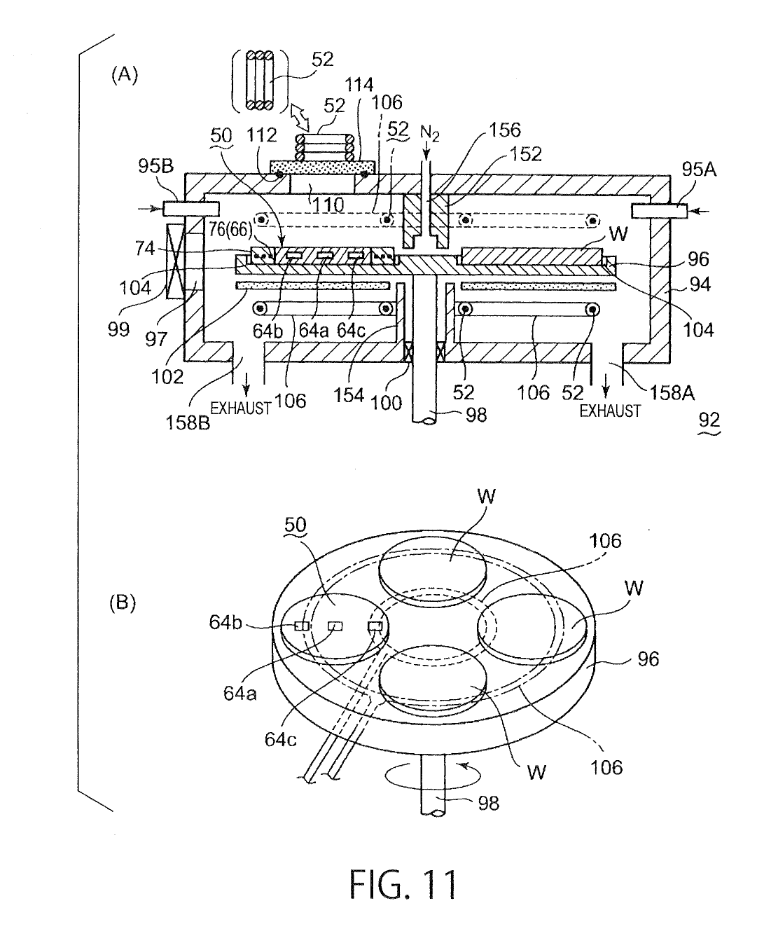

FIGS. 11A and 11B are diagrams showing such a first variation of the heat treatment apparatus, FIG. 11(A) being a cross-sectional view of the apparatus and FIG. 11(B) being a perspective view of a wafer table. In the Figures, the same reference numerals are used for the same components or elements as those shown in FIGS. 1 through 10. A description of a temperature control system as shown in FIG. 3 will be omitted. The heat treatment apparatus 92 is a semibatch-type heat treatment apparatus as disclosed e.g. in Japanese Patent Laid-Open Publication No. 2010-056470 and which is capable of processing several semiconductor wafers W at a time.

As shown in FIG. 11(A), the heat treatment apparatus 92 includes an evacuable processing container 94 e.g. made of stainless steel. The processing container 94 has a transfer opening 97 for carrying a semiconductor wafer W into and out of the processing container 94, and a gate valve 99. In the processing container 94 is disposed a large-diameter disk-shaped wafer table 96 rotatably mounted and supported on the upper end of a rotating shaft 98. The rotating shaft 98 is hermetically and rotatably supported by a bearing 100, having a magnetic fluid seal, at the bottom of the processing container 94.

The wafer table 96 is made of, for example, quartz or a ceramic material. A heating unit 102, e.g. comprised of a heater, is provided under the wafer table 96. The heating unit 102 may be embedded in the wafer table 96.

To divide the interior of the processing container 94 into a plurality of, e.g. two, zones along the circumferential direction, a downwardly-protruding upper protrusion 152 is provided on the ceiling, while an upwardly-protruding lower protrusion 154 is provided on the bottom. The upper protrusion 152 and the lower protrusion 154 extend toward the wafer table 154, and the front ends of the protrusions 154, 156 lie close to each other, forming a narrow space through which a gas hardly flows. The upper protrusion 152 and the lower protrusion 154 extend radially outward from the center of the processing container 94, thereby partitioning (dividing) the interior of the processing container 94 into a plurality of (e.g. two) processing zones.

A separating gas introduction port 156 is formed in the upper protrusion 152. An inert gas, e.g. N₂ gas, as a separating gas is introduced from the introduction port 156 into the processing container 94 to separate the interior into the processing zones with the separating gas. The two processing zones are provided with gas introduction arrangements 95A, 95B, e.g. comprised of gas nozzles, and exhaust ports 15A, 15B so that processing gases, necessary for the respective processing zones, can be supplied into and evacuated from the respective processing zones. The division number of processing zones is not limited to two.

A plurality of, for example four as shown in FIG. 11(B), reception recesses 104, each for receiving and holding a semiconductor wafer W, are provided in the upper surface of the wafer table 96 along the circumferential direction. A temperature-measuring substrate 50 according to the present invention is held in one of the reception recesses 104. A predetermined heat treatment, e.g. film forming processing, is carried out by introducing different necessary gases from the gas introduction arrangements 95A, 95B into the processing zones while rotating the wafer table 96.

While any of the above-described temperature-measuring substrates according to the first to eighth embodiments can be used as the above temperature-measuring substrate 50, the temperature-measuring substrate of the fourth embodiment, shown in FIG. 9(A), is used in the illustrated embodiment. In the case where a temperature-measuring substrate, having a projecting antenna installation portion 74 as shown in FIG. 8(B), is used, the wafer table 96 is provide with a recess corresponding to the projecting portion 74.

A transmitting/receiving antennas 52 is provided just under or just above the wafer table 96. The transmitting/receiving antenna 52, when it is provided just under the wafer table 96, is shown by the solid lines in FIG. 11(A). The transmitting/receiving antenna 52 is housed in a insulating tube 106, such as a quartz tube, to protect it from a corrosive gas.

The transmitting/receiving antenna 52 has inner and outer looped portions, both looped in the circumferential direction of the wafer table 96. The transmitting/receiving antenna 52 is located just under the peripheral antenna portion 66 of the temperature-measuring substrate 50 in order to prevent a decrease in the reception level.

Instead of disposing the transmitting/receiving antenna 52 just under or above the wafer table 96, it is possible to dispose the transmitting/receiving antenna 52 in a position corresponding to a portion, lying in a predetermined angular range, of the trajectory of rotation (revolution) of the temperature-measuring substrate 50, and to perform communication during the period when the temperature-measuring substrate 50 lies within the predetermined angular range. In particular, in this embodiment the ceiling portion of the processing container 94 is provided with an opening 110 corresponding to the predetermined range of the trajectory of rotation of the temperature-measuring substrate 50. A transmissive window 114 of e.g. quartz glass is provided on the outer side of the opening 110 with a sealing member 112, such as an O-ring, interposed between the window 114 and the outer surface of the processing container 94. The transmitting/receiving antenna 52 is provided on the outer side of the transmissive window 114. The transmitting/receiving antenna 52 is spirally coiled in a horizontal direction and extends in the vertical direction.

When the rotationally moving temperature-measuring substrate 50 has reached a position under the opening 110, i.e. when the substrate 50 has fallen within the predetermined angular range, measuring signals are emitted from the transmitting/receiving antenna 52 toward the substrate 50. As shown in the brackets in FIG. 11(A), the transmitting/receiving antenna 52 may be spirally coiled in the vertical direction and extend in a horizontal direction.

In the above-described variation, it is of course possible to separate the transmitting/receiving antenna 52 into a transmitting antenna and a receiving antenna. The above-described variation of the heat treatment apparatus can achieve the same advantageous effects as the heat treatment apparatus of the preceding embodiment shown in FIG. 1. Furthermore, the temperatures of substrates to be processed can be measured even when the substrates are rotating or revolving in the above-described manner. Thus, the temperatures of the substrates can be measured during heat treatment.

<Second Variation of Heat Treatment Apparatus>

A second variation of the heat treatment apparatus will now be described. The heat treatment apparatuses shown in FIGS. 1 and 11 are adapted to process a plurality of semiconductor wafers W at a time. The present invention, however, can also be applied to a heat treatment apparatus which processes semiconductor wafers W in a one-by-one manner.

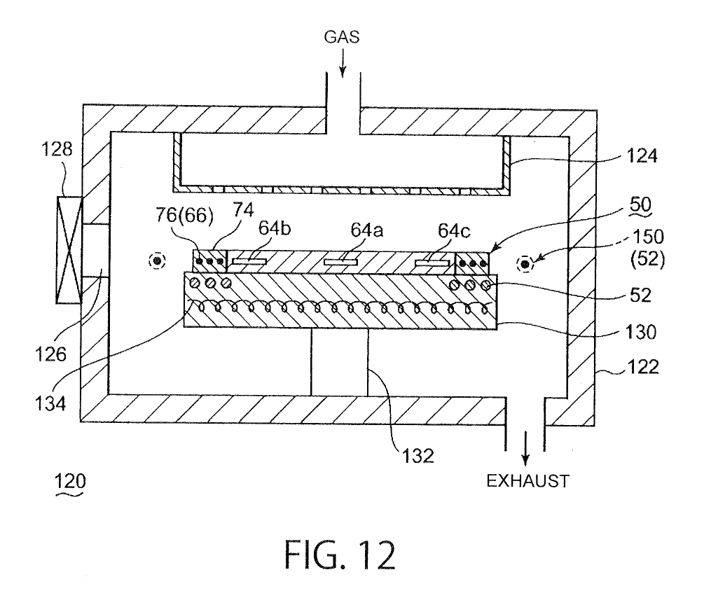

FIG. 12 shows such a second variation of the heat treatment apparatus. In FIG. 12, the same reference numerals are used for the same components or elements as those shown in FIGS. 1 through 11. A description of a temperature control system as shown in FIG. 3 will be omitted. As shown in FIG. 12, the heat treatment apparatus 120 includes an evacuable processing container 122 e.g. made of stainless steel.

The processing container 122 is provided with a gas introduction arrangement 124, e.g. comprised of a shower head, for introducing a gas into the processing container 122. The processing container 122 has a transfer opening 126 for carrying a semiconductor wafer W into and out of the processing container 122, and a gate valve 128. In the processing container 122 is disposed a disk-shaped wafer table 130 supported on a support post 132 mounted upright on the container bottom.

The wafer table 130 is made of, for example, quartz or a ceramic material. A heating unit 134, e.g. comprised of a heater, is provided in the interior of the wafer table 130. A semiconductor wafer W or a temperature-measuring substrate 50 according to the present invention is to be selectively placed on the upper surface of the wafer table 130. A predetermined heat treatment, e.g. film forming processing, of a semiconductor wafer W is carried out by introducing a necessary gas from the gas introduction arrangement 124 into the processing container 122.

While any of the above-described temperature-measuring substrates according to the first to eighth embodiments can be used as the temperature-measuring substrate 50, the temperature-measuring substrate of the fourth embodiment, shown in FIG. 9(A), is used in the illustrated embodiment.

A transmitting/receiving antenna 52 is embedded in an insulated state in the wafer table 130. The transmitting/receiving antenna 52 is looped in the circumferential direction of the wafer table 130 and located in a position corresponding to the peripheral portion of the temperature-measuring substrate 50. Instead of thus providing the transmitting/receiving antenna 52 within the wafer table 96, it is possible to provide a looped transmitting/receiving antenna 52, e.g. housed in a quartz tube, around the wafer table 130 such that it surrounds the circumference of the temperature-measuring substrate 50, as shown by the position 150 in FIG. 12.

In this embodiment a heater is used as the heating unit 134 and is embedded in the wafer table 130. The present invention, however, can also be applied to a heat treatment apparatus which uses a heating lamp, disposed at the bottom of a processing container, as a heating unit 134. Heat rays from the heating lamp are transmitted through a transmissive window to a thin wafer table 130, thereby heating a semiconductor wafer W in an indirect manner. In this case, the transmitting/receiving antenna 52 may be disposed just under the transmissive window.

In the above-described variation, it is of course possible to separate the transmitting/receiving antenna 52 into a transmitting antenna and a receiving antenna. According to the above-described variation, the distribution of the temperature of a semiconductor wafer W can be determined accurately.

Though the piezoelectric element 68 of lanthanum tantalic acid gallium aluminum (LTGA) is used in the above-described embodiments, other materials may be used for the piezoelectric element 68. Examples of other usable materials include crystal (SiO₂), zinc oxide (ZnO), Rochelle salt (potassium sodium tartrate: KNaC₄H₄O₆), lead zirconate titanate (PZT: Pb(Zr, Ti)O₃), lithium niobate (LiNbO₃), lithium tantalate (LiTaO₃), lithium tetraborate (Li₂B₄O₇), langasite (La₃ga₅SiO₁₄), aluminum nitrate, tourmaline, and polyvinylidene fluoride (PVDF).

The foregoing description has been made for a case where the process-target substrate is a semiconductor wafer, which may be a silicon substrate and a compound semiconductor substrate, such as a GaAs, SiC or GaN substrate. The process-target substrate is not limited to substrates of such type, but may be a glass substrate for use in a liquid crystal display device, or a ceramic substrate.

1. A temperature-measuring substrate for use in a heat treatment apparatus for performing heat treatment to a process-target substrate, comprising:
a substrate body;
an oscillator including a piezoelectric element and provided in the substrate body; and
an antenna portion connected to the oscillator and provided at a peripheral portion of substrate body.

2. The temperature-measuring substrate according to claim 1, wherein the antenna portion is provided in an antenna installation portion made of an insulating material provided at a peripheral portion of the substrate body.

3. The temperature-measuring substrate according to claim 2, wherein the antenna installation portion has the shape of a circular ring.

4. The temperature-measuring substrate according to claim 2, wherein the antenna installation portion projects radially outward from a part of the periphery of the substrate body.

5. The temperature-measuring substrate according to claim 1, wherein the oscillator is housed and sealed in a case made of an insulating material or a semiconducting material.

6. The temperature-measuring substrate according to claim 1, including a plurality of sets of the oscillator and the antenna portion connected to the oscillator.

7. The temperature-measuring substrate according to claim 6, wherein the natural frequencies of the oscillators differ from one another.

8. The temperature-measuring substrate according to claim 6, wherein the numbers of turns of the antenna portions differ from one another.

9. The temperature-measuring substrate according to claim 1, wherein the substrate body is formed of a material which is the same as the process target substrate.

10. A heat treatment apparatus for performing heat treatment of a plurality of process-target substrates, comprising:
an evacuable vertical processing container;
a heating unit provided to heat the process-target substrates;
a holding unit configured to hold the process-target substrates and the temperature-measuring substrate according to claim 1, and which is to be loaded into and unloaded from the processing container;
a gas introduction arrangement configured to introduce a gas into the processing container;
a transmitting antenna connected to a transmitter to transmit measuring radio waves to the temperature-measuring substrate;
a receiving antenna connected to a receiver to receive radio waves emitted by the oscillator of the temperature-measuring substrate;
a temperature analyzer configured to determine the temperature of the oscillator based on radio waves received by the receiving antenna; and
a temperature controller configured to control the heating unit based on the temperature determined by the temperature analyzer.

11. The heat treatment apparatus according to claim 10, wherein the transmitting antenna and the receiving antenna are integrated as a transmitting/receiving antenna, and the transmitter and the receiver are integrated as a transceiver.

12. The heat treatment apparatus according to claim 10, wherein the heating unit includes a plurality of zone-heating heaters whose powers are individually controllable, whereby an interior of the processing container is divided into a plurality of heating zones.

13. The heat treatment apparatus according to claim 10, wherein the transmitting antenna and the receiving antenna are disposed outside or inside the processing container in a position corresponding to the temperature-measuring substrate.

14. The heat treatment apparatus according to claim 10, wherein the transmitter is configured to transmit radio waves at varying frequencies, varying in a frequency range around the natural frequency of the oscillator of the temperature-measuring substrate, in a time-divisional manner.

15. The heat treatment apparatus according to claim 14, wherein a temperature calculating function is stored in the temperature analyzer, and wherein the temperature calculating function is configured to allow determination of the temperature of the oscillator based on a resonance frequency of the oscillator of the temperature-measuring substrate which varies depending on the temperature of the oscillator.

16. A heat treatment apparatus for performing heat treatment of a process-target substrate, comprising:
an evacuable processing container;
a heating unit provided to heat the process-target substrate;
a substrate table configured to allow placement thereon of the process target substrate or the temperature-measuring substrate according to claim 1;
a gas introduction arrangement configured to introduce a gas into the processing container;
a transmitting antenna connected to a transmitter to transmit measuring radio waves to the temperature-measuring substrate;
a receiving antenna connected to a receiver to receive radio waves emitted by the oscillator of the temperature-measuring substrate;
a temperature analyzer configured to determine the temperature of the oscillator based on radio waves received by the receiving antenna; and
a temperature controller configured to control the heating unit based on the temperature determined by the temperature analyzer.

17. The heat treatment apparatus according to claim 16, wherein the transmitting antenna and the receiving antenna are disposed in a position corresponding to the peripheral portion of the temperature-measuring substrate.

18. The heat treatment apparatus according to claim 16, wherein the transmitting antenna and the receiving antenna are integrated as a transmitting/receiving antenna, and the transmitter and the receiver are integrated as a transceiver.

19. A heat treatment apparatus for performing heat treatment of a plurality of process-target substrates, comprising:
an evacuable processing container;
a heating unit provided to heat the process-target substrates;
a rotatable substrate table configured to allow placement thereon the process-target substrates and the temperature-measuring substrate according to claim 1 in different angular positions;
a gas introduction arrangement configured to introduce a gas into the processing container;
a transmitting antenna connected to a transmitter to transmit measuring radio waves to the temperature-measuring substrate;
a receiving antenna connected to a receiver to receive radio waves emitted by the oscillator of the temperature-measuring substrate;
a temperature analyzer configured to determine the temperature of the oscillator based on radio waves received by the receiving antenna; and
a temperature controller configured to control the heating unit based on the temperature determined by the temperature analyzer.

20. The heat treatment apparatus according to claim 19, wherein the transmitting antenna and the receiving antenna are disposed in a position corresponding to the trajectory of rotation of the temperature-measuring substrate.

21. The heat treatment apparatus according to claim 19, wherein the transmitting antenna and the receiving antenna are disposed in a position corresponding to a portion, lying in a predetermined angular range, of the trajectory of rotation of the temperature-measuring substrate, and wherein communication is performed during the period when the temperature-measuring substrate lies within the predetermined angular range.

22. The heat treatment apparatus according to claim 19, wherein the transmitting antenna and the receiving antenna are integrated as a transmitting/receiving antenna, and the transmitter and the receiver are integrated as a transceiver.
